(19) United States
(12) Patent Application Publication
(10) Pub. No.: US 2016/0218354 A1
(43) Pub. Date: Jul. 28, 2016

(54) Hybrid Electrode For Non-Aqueous Electrolyte Secondary Battery

(71) Applicant: UNIVERSITE CATHOLIQUE DE LOUVAIN, Louvain-La-Neuve (BE)

(72) Inventors: Alexandru Vlad, Court-Saint-Etienne (BE); Jean-François Gohy, Neuville-en-Condroz (BE); Sorin Melinte, Bruxelles (BE)

(21) Appl. No.: 14/917,263

(22) PCT Filed: Sep. 8, 2014
(86) PCT No.: PCT/EP2014/069102

§ 371 Date: Mar. 7, 2016

(30) Foreign Application Priority Data
Sep. 9, 2013 (EP) 13183530.8

(51) Int. Cl. H01M 4/36; H01M 4/485; H01M 4/62; H01M 4/505; H01M 4/525; H01M 4/60; H01M 4/58

(52) U.S. Cl. CPC H01M 4/364; H01M 4/602; H01M 4/485; H01M 4/5825; H01M 4/505; H01M 4/525; H01M 4/625; H01M 2004/028

(57) ABSTRACT

The present invention relates to hybrid positive electrode comprising a composition which comprises a first active material being a lithium-containing compound, a sodium-containing compound, or an electroactive conjugated polymer; a second active material being a polymer containing a nitroxide radical, and electrically conductive particles. In another aspect, the present invention relates to a non-aqueous electrolyte secondary battery comprising a hybrid positive electrode according to the present invention, a negative electrode and an electrolyte.

### TECHNICAL FIELD

The present invention relates generally to the field of a non-aqueous electrolyte secondary battery. In particular, the present invention relates to a positive electrode having improved input characteristics, e.g. a pulse charge characteristic, without a significant decrease in energy density as well as improved output characteristics.

### BACKGROUND OF THE INVENTION

High specific energy, high power density, long cycle life, low cost and safer batteries are required for the realization of electric vehicles (Tarascon et al., Nature, 2001, 414, 359-367; Armand et al., 2008, 451, 652-657; Choi et al., Angewandte Chemie International Edition, 2012, 51, 9994-10024). Current Li-ion batteries have highest energy density but they suffer from low power density. There is always a trade-off between high specific energy and high power density. Li-ion Batteries store energy by virtue of reversible Coulombic reaction occurring at both electrodes. It involves charge transfer in the bulk electrode materials and diffusion of ions from one electrode to the other. However, both diffusion and charge transfer (redox reaction) are limited by slow kinetics resulting in slow recharge and power delivery when needed. The electrochemical supercapacitors store energy through accumulation of ions on the electrode surface and have very low energy storage capacity but very high power density.

The most intuitive approach to combine high energy and power density within a single device was to combine the different types of energy storage sources. So far, mainly hybridization between electric double layer capacitors and battery materials has been explored (Cericola et al., Electrochimica Acta, 2012, 72, 1-17). The electrochemical response of the hybridized device is the sum of the response of separate devices: a flat-potential profile for the battery component enclosed by a slope-potential profile for the capacitor component. The contribution to the total stored charge is proportional to the amount of each of the components while the electrode configuration and composition controls the power and energy delivery performances. This type of hybridization improves the energy and power performances yet, requiring further optimization. The primary drawback comes from the fact that power and energy performances are decoupled. At high current densities, mainly the capacitive component will respond. The hybrid will store more energy than the capacitor alone yet, much less compared the battery material alone (the specific capacity of the hybrid being strongly diminished by the relatively low specific capacity provided by electric double layer capacitors). Lastly, the slope-potential profile contribution of the electric double layer capacitors component in the electrochemical response is detrimental for most of the applications where a constant power supply is required.

EP 2 590 244 discloses a non aqueous electrolyte secondary battery comprising a positive electrode including a first active material capable of occluding and releasing a lithium ion and a second active material capable of occluding and releasing an anion; a negative electrode including a negative electrode active material capable of occluding and releasing a lithium ion; and an electrolyte containing a salt of a lithium ion and the anion. The second active material is a polymer having a tetrachalcogenofulvalene skeleton in a repeating unit. The polymer is combined with LiFePO₄ as first active material.

JP 2007-213992 discloses an electrode for a secondary battery containing a nitroxyl radical compound. The conductive material-containing radical compound is obtained by synthesizing the nitroxyl radical compound by liquid-phase anionic polymerization in an electrolytic bath and then immediately adding a conductor formed from acetylene black to increase the interface between the radical compound and the conductor. Although this method is expected to produce radical compound with good electrochemical properties, solvent is still used during the synthesis and subsequent processing is required to remove this after reaction. Due to the insolubility of the radical compound formed, the mixing of acetylene black therewith is not efficient. The particles of acetylene black remains at the outer surface of the material formed.

JP 2009-277432 discloses electrode for a secondary cell made of a positive electrode comprising a positive electrode collector and a positive electrode active substance layer containing a radical compound, a lithium compound oxide, and a conductor that is formed on the surface of the collector and has an electrode surface on the side opposite the surface of the collector. The concentration of radical compound on the electrode surface-side in the positive electrode active substance layer is greater than the concentration of radical compound on the collector side in the positive electrode active substance layer.

Qian Huang et al. (J. Pow. Sources 233, 2013, 69-73) disclose an electrode comprising soluble PTMA and LiFePO₄ resulting in fast capacity loss.

LiFePO₄ (LFP) has gained huge attention as a lithium-ion battery material as it has the potential of (1) high-power characteristic (as compared to standard/classical Li-ion battery materials), (2) abundance and low cost of constituent materials, Fe and phosphate, (3) it uses non-toxic materials (Co, Ni being known as carcinogenic), (4) thermal and over-potential stability unlike standard materials that become highly oxidizing leading to electrolyte inflammation. Nevertheless, high-power (fast discharge and especially recharge rate/time) and long-term cycling stability (especially at high rates) are strongly dependent on the morphology of LFP particles.

The present invention aims at providing a device that addresses the above-discussed drawbacks of the prior art.

In particular, it is an object of the present invention to provide a hybrid positive electrode having improved input and output characteristics.

### SUMMARY OF THE INVENTION

In a first aspect of the present invention, a hybrid positive electrode is provided. Said hybrid positive electrode comprises a composition which includes:
(a) a first active material being a lithium-containing compound, a sodium-containing compound or electroactive conjugated polymer,
(b) a second active material being a polymer containing a nitroxide radical, and
(c) electrically conductive particles, parts thereof being dispersed within said second active material.
   Preferably, the weight content of said electrically conductive particles in the composition is lower than 25 wt % based on the total amount of said first and second active materials and electrically conductive particles. Preferably, the electrically conductive particles are electrically conductive carbon particles. Said second active material may be prepared according to the process as disclosed herein which provides to it unexpected physical properties in terms of power performance such as rate performance or output energy density. Parts of the electrically conductive particles may be contained within said second active material, preferably may be homogeneously dispersed within said second active material. Preferably, the second active material may have an output energy density greater than 240 Wh/kg at a power density of 3.5 kW/kg (10 C) or greater than 170 Wh/kg at power density of 10.23 kW/kg (30 C). In particular, such output energy density values may be obtained for a second active material as defined herein comprising from 5 to 20 wt %, preferably from 5 to 15 wt %, of electrically conductive particles, preferably electrically conductive carbon particles as defined herein, based on the amount of second active material. The above-mentioned values of output energy density may be preferably observed when the second active material is a cross-linked poly(2,2,6,6-tetramethylpiperidinyl-oxy-4-yl methacrylate), preferably obtained by the process disclosed herein. Such high output energy density may be obtained due to the particular steps of the present process allowing the homogeneous dispersion of the electrically conductive particles within the polymer so-formed. The output energy density observed for the second active material according to the present invention is dramatically greater than the output energy density of polymer containing a nitroxide radical and prepared according to other processes.

Said electrically conductive particles may have any shape and may not be limited to spherical or quasi spherical particles. The electrically conductive particles may be electrically conductive carbon particles or, metallic nanowires or particles selected from the group consisting of silver, nickel, iron, copper, zinc, gold, tin, indium and oxides thereof. Preferably the electrically conductive particles may be electrically conductive carbon particles. The electrically conductive carbon particles may be carbon nanotubes, carbon fibers, amorphous carbon, mesoporous carbon, carbon black, exfoliated graphitic carbon, activated carbon or surface enhanced carbon. Preferably, the weight content of said electrically conductive carbon particles in the composition is lower than 25 wt % based on the total amount of said first and second active material and electrically conductive carbon particles, preferably lower than 20 wt %, more preferably ranges from 0.5 to 20 wt %, most preferably from 1 to 20 wt %, even most preferably from 5 to 20 wt %, in particular from 5 to 15 wt % based on the total amount of said first and second active material and electrically conductive carbon particles.

In a preferred embodiment, said second active material has solubility lower than 10 wt % in any solvent at room temperature, preferably lower than 5 wt %, more preferably lower than 1 wt %, most preferably lower than 0.1 wt %. Said second active material may have solubility lower than 10 wt % in organic solvent or water at room temperature, preferably lower than 5 wt %, more preferably lower than 1 wt %, most preferably lower than 0.1 wt %. In particular, said second active material may be insoluble in any solvent, preferably in any organic or aqueous solvent. For example, the second active material may be insoluble in dichloromethane, chloroform, toluene, benzene, acetone, ethanol, methanol, hexane, N-methyl pyrrolidone, dimethyl sulfoxide, acetonitrile, tetrahydrofuran and/or dioxane. In particular, the second active material is a cross-linked poly(2,2,6,6-tetramethylpiperidinyl-oxy-4-yl methacrylate), noted PTMA hereunder.

In a preferred embodiment, said first active material is a lithium-containing material, preferably LiFePO₄, LiCoO₂ or LiMn₂O₄.

Preferably, the first and second active materials may be selected such that the equilibrium redox potential of the second active material is equal or greater, preferably greater, than the equilibrium redox potential of the first active material, or alternatively, such that the equilibrium redox potential of the second active material is equal or lower, preferably lower, than the equilibrium redox potential of the first active material. In a preferred embodiment, the rate performance of the second material is greater than the rate performance of the first active material. In a preferred embodiment, the electrode polarization of the second material is lower than the electrode polarization of the first active material.

In a preferred embodiment, after charging and/or discharging of the hybrid positive electrode, an internal charge transfer may occur between the second active material and the first active material.

In another aspect of the present invention, a non-aqueous electrolyte secondary battery is provided. Said non-aqueous electrolyte secondary battery comprises a hybrid positive electrode according to the present invention, a negative electrode and an electrolyte.

In a third aspect of the present invention, the hybrid positive electrode according to the present invention is suitable as one of the components in an electricity storage device.

### BRIEF DESCRIPTION OF THE DRAWINGS

FIG. 1 represents the voltage as function of specific capacity at various C-rate for an electrode comprising cross-linked PTMA or LiFePO₄.

FIG. 2 represents the voltage profile of the hybridized cross-linked PTMA/LiFePO₄ electrode according to the present invention at a current density of 26 mAh/g.

FIG. 3 represents the capacity retention at 5 C rate for LiFePO₄, cross-linked PTMA and the hybrid positive electrode according to the present invention as function of the number of cycles.

FIG. 4 represents the capacity retention of LiFePO₄, cross-linked PTMA and the hybrid positive electrode at various C-rate.

FIG. 5 represents the voltage profile for a hybridized cross-linked PTMA/LiCoO₂ positive electrode according to the present invention.

FIG. 6 represents the voltage profile for a hybridized cross-linked PTMA/LiMn₂O₄ positive electrode according to the present invention.

### DETAILED DESCRIPTION OF THE INVENTION

In a first aspect of the present invention, a hybrid positive electrode is provided. Said hybrid positive electrode comprises a composition which includes:
(a) a first active material being a lithium-containing compound, a sodium-containing compound or electroactive conjugated polymer,
(b) a second active material being a polymer containing a nitroxide radical, and
(c) electrically conductive particles, preferably electrically conductive carbon particles, parts thereof being dispersed within said second active material; the weight content of said electrically conductive particles in the composition is lower than 25 wt % based on the total amount of said first and second active materials and electrically conductive particles.
   Preferably, parts of the electrically conductive particles, preferably electrically conductive carbon particles, dispersed within said second active material are homogeneously dispersed therein.
   Said second active material may be obtained by a process comprising the steps of:
   (a) providing electrically conductive particles, a monomer, and a cross-linking agent to form a reaction mixture,
   said monomer being of formula (II) R^{a}R^{b}C¹═C²R^{c}((X)ₘ—R) (II) wherein
   R^{a}, R^{b}, R^{c} each are independently from the other, hydrogen or an hydrocarbyl group having from 1 to 20 carbon atoms;
   X is a spacer; m is an integer from 0 to 5;
   R is a substituent having a nitroxide radical as functional group or a nitrogen atom able to form nitroxide radicals under oxidative conditions;
   (b) bringing said reaction mixture to a process temperature which is greater than the melting temperature of the monomer and than the temperature at which the polymerization is activated, said polymerization is considered to be activated when at least 5% of the monomer was converted,
   (c) retrieving said second active material, preferably step (b) is carried out in a reaction mixture comprising not more than 300 wt %, preferably not more than 200 wt %, more preferably not more than 100 wt %, most preferably not more than 30 wt %, of an organic solvent with respect to the total weight of the monomer.

In a preferred embodiment, said second active material is a polymer wherein at least part of the polymeric chain is of formula (I)—[—C¹(R^{a})(R^{b})—C²((X)ₘ—R)(R^{c})—]ₙ—wherein R^{a}, R^{b}, R^{c} each are independently from the other, hydrogen or an hydrocarbyl group having from 1 to 20 carbon atoms, preferably R^{a}, R^{b}, and R^{c} each are, independently from the other, hydrogen or C₁-C₆ alkyl or C₆-C₁₈ aryl, more preferably, R^{a}, R^{b}, R^{c} are hydrogen or methyl;

X is a spacer, preferably X is selected from the group consisting of X is selected from the group consisting of C₁-C₂₀ alkyl, C₆-C₂₀ aryl, C₂-C₂₀ alkenyl, C₃-C₂₀ cycloalkyl, C₁-C₂₀ alkoxyl, —C(O)—, O—C(O)—, —CO₂—, C₁-C₂₀ ether, C₁-C₂₀ ester. Preferably, X may be selected from the group consisting of C₁-C₆ alkyl, C₆-C₁₂ aryl, C₂-C₆ alkenyl, C₃-C₁₀ cycloalkyl, C₁-C₆ alkoxyl, —C(O)—, O—C(O)—, —CO₂—, C₁-C₆ ether, C₁-C₆ ester. More preferably, X may be selected from the group consisting of C₁-C₆ alkyl, C₆-C₁₂ aryl, C₂-C₆ alkenyl, C₁-C₆ alkoxyl, —C(O)—, O—C(O)—, —CO₂—;
m is an integer from 0 to 5, preferably from 0 to 2, more preferably m is 0;
n is an integer of at least 10, preferably from 10 to 10⁶, more preferably from 50 to 10⁶;
R is selected from the group consisting of:

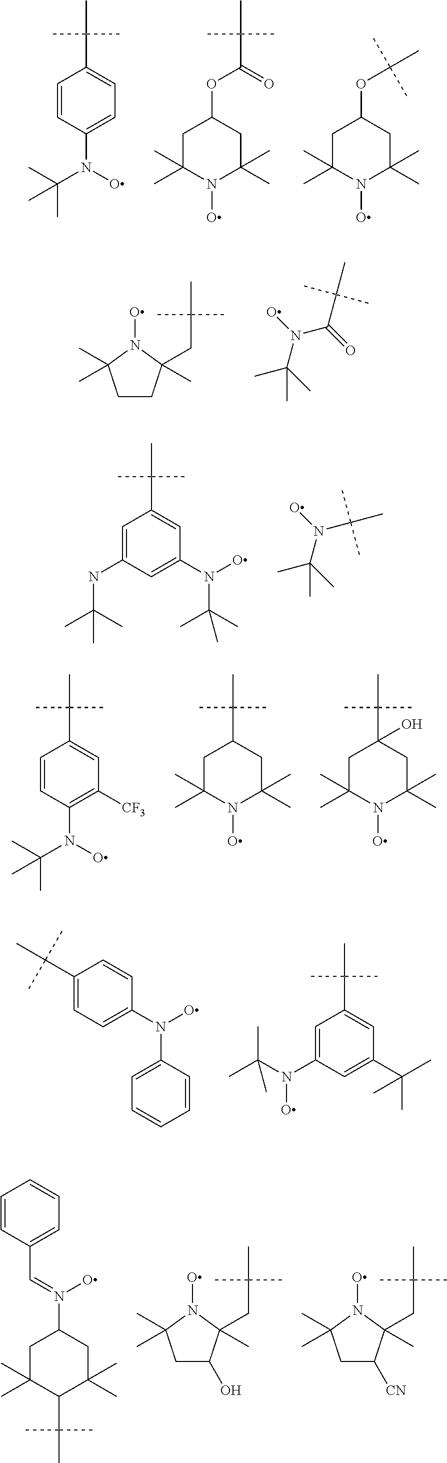

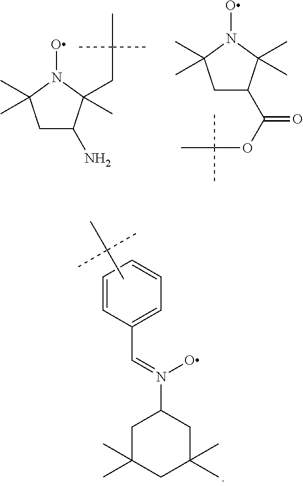

For sake of clarity, hydrogen atoms are not represented on the above substituents. The dotted lines cross the chemical bond by which the substituent R is linked to the spacer X or to the carbon atom C².

Preferably, R is selected from the group consisting of:

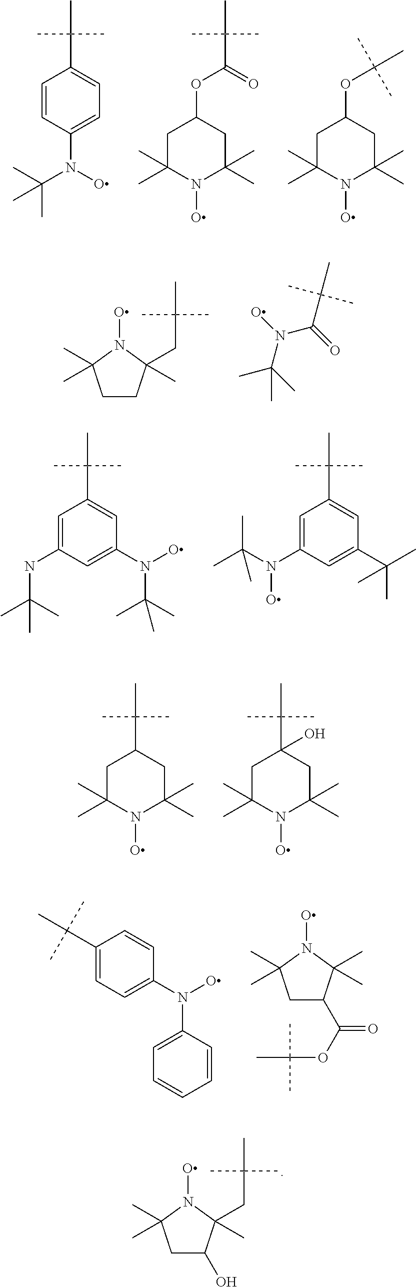

The second active material may have output energy density greater than 240 Wh/kg, preferably greater than 250 Wh/kg, more preferably greater than 260 Wh/kg most preferably greater than 270 Wh/kg at a power density of 3.5 kW/kg (10 C). Said second active material may also have output energy density greater than 170 Wh/kg, preferably greater than 180 Wh/kg, more preferably greater than 185 Wh/kg most preferably greater than 195 Wh/kg at power density of 10.23 kW/kg (30 C). The output energy density was measured according to standard charge/discharge experiments. The battery was charged at slow rate and then discharged at higher rates. Discharge time (t), discharge current (I) and average discharge voltage are directly extracted from the experiment. The output energy density is calculated by (I*V*t)/m wherein m is the mass of the electrically conductive polymer. The power density is calculated by I*V/m. The above-mentioned values of output energy density may be preferably observed when the second active material is a cross-linked poly(2,2,6,6-tetramethylpiperidinyl-oxy-4-yl methacrylate), preferably obtained by the present process disclosed herein. Such high output energy density may be obtained due to the particular steps of the present process allowing the homogeneous dispersion of the electrically conductive particles within the second active material so-formed. In particular, such output energy density values may be obtained for a second active material as defined herein comprising from 5 to 20 wt % of electrically conductive particles, preferably electrically conductive carbon particles as defined herein, based on the total amount of the second active material. Output energy density values obtained with a second active material prepared according processes known in the art such as liquid polymerization as disclosed in JP 2007-213992 or JP 2009-277432 were dramatically lower than the values obtained with the second active material prepared according to the present invention.

Said second active material may be insoluble in any organic solvent. Said second active material may have solubility in organic solvent lower than 10 wt % in any solvent, preferably in any organic solvent or aqueous solvent, at room temperature, preferably lower than 5 wt %, more preferably lower than 1 wt %, most preferably lower than 0.1 wt %. For example, the second active material may be insoluble in organic solvent such as dichloromethane, chloroform, toluene, benzene, acetone, ethanol, methanol, hexane, N-methyl pyrolidone, dimethyl sulfoxyde, acetonitrile, tetrahydrofuran, dioxane or water. An insoluble second active material is of great interest in energy storage applications or battery applications. When such second active material is incorporated in a battery, for example as one of the constituent of the positive electrode, it will therefore not be solubilized in the electrolyte when the battery will be charged or discharged. An electrode containing the second active material according to the present invention will therefore have higher capacity retention rate over cycle lifetime. The degradation of the positive electrode is strongly limited.

The second active material, preferably prepared according to a process detailed herein, may have a percentage of cross-linking ranging from 0.1 to 15%, preferably from 0.5 to 10%, more preferably from 1 to 8%, most preferably from 3 to 7%. The percentage of cross-linking is the (molar ratio between the cross-linking agent and the monomer)*100.

As mentioned above, said second active material may be obtained by the process comprising the steps of:

(a) providing electrically conductive particles, preferably electrically conductive carbon particles, the monomer, and a cross-linking agent to form a reaction mixture,
(b) bringing said reaction mixture to a process temperature which is greater than the melting temperature of the monomer and than the temperature at which the polymerization is activated, said polymerization is considered to be activated when at least 5% of the monomer was converted,
(c) retrieving a second active material.

Preferably, the process may comprise the steps of: (a) providing electrically conductive particles, the monomer, and a cross-linking agent to form a reaction mixture,

(b′) bringing said reaction mixture to a first process temperature to form a slurry where the polymerization reaction has not been initiated, said polymerization is considered to be not initiated when less than 5% of the monomer was converted,
(b″) heating said slurry to a second process temperature higher than the first process temperature to activate the polymerization initiator and thus to polymerize the monomer,
(c) retrieving a second active material.

Preferably, steps (b) or (b′) and (b″) of the process are carried out in a reaction mixture comprising not more than 250 wt %, preferably not more than 200 wt %, more preferably not more than 100 wt %, even more preferably not more than 30 wt %, of an aqueous or organic solvent, most preferably not more than 15 wt % of an organic solvent, even most preferably not more than 7 wt % of an organic solvent, in particular not more than 3 wt % of an organic solvent with respect to the total weight of the monomer. In particular, the steps (b) or (b′) and (b″) of the process are carried out in a reaction mixture free of any organic solvent. Examples of solvent are dichloromethane, chloroform, toluene, benzene, acetone, ethanol, methanol, hexane, N-methyl pyrolidone, dimethyl sulfoxyde, acetonitrile, tetrahydrofuran or dioxane. Alternatively, steps (b) or (b′) and (b″) of the process may be carried out in a reaction mixture comprising from more than 30 wt % to 300 wt % of an aqueous or organic solvent with respect to the total weight of the monomer, preferably from more than 30 wt % to 200 wt %, more preferably from more than 30 wt % to 100 wt % of an aqueous or organic solvent with respect to the total weight of the monomer. Alternatively, steps (b) or (b′) and (b″) of the process may be carried out in a reaction mixture comprising from more than 100 wt % to 300 wt %, preferably from more than 100 wt % to 250 wt % of an aqueous or organic solvent with respect to the total weight of the monomer.

Said monomer is of formula (II) R^{a}R^{b}C¹═C²R^{c}((X)ₘ—R) (II) wherein R^{a}, R^{b}, R^{c}, X, and m are as defined above with respect to the polymer of formula (I). R is a substituent having a nitroxide radical as functional group or a nitrogen atom able to form nitroxide radicals under oxidative conditions. In a preferred embodiment in said monomer, R is a substituent having a nitroxide radical as functional group and may be selected from the group consisting of:

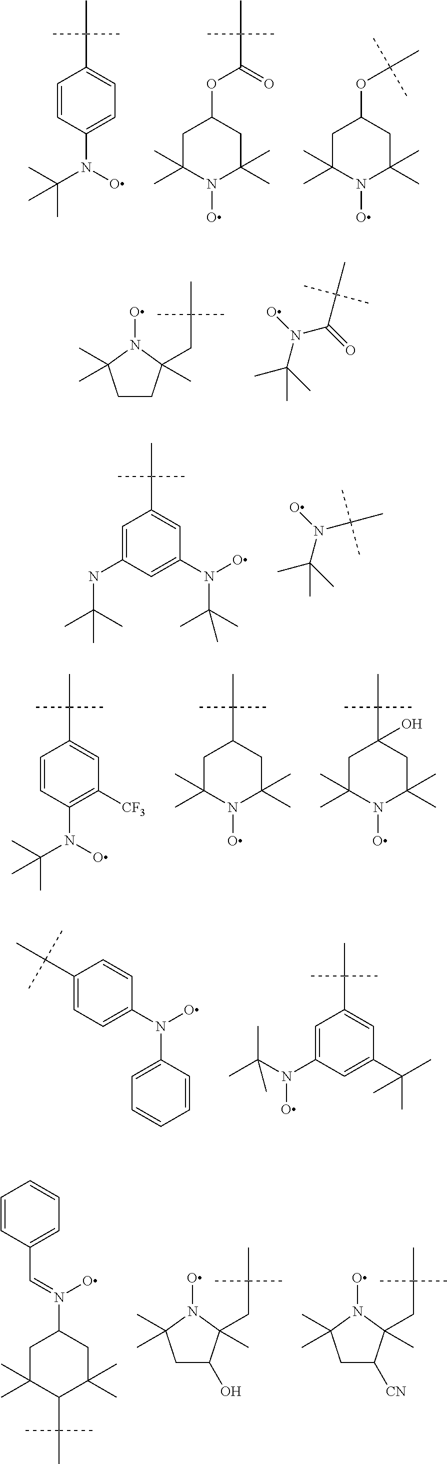

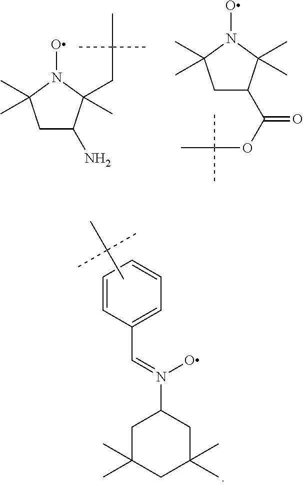

For sake of clarity, hydrogen atoms are not represented on the above substituents R. The dashed lines cross the chemical bond by which the substituent R is linked to the spacer X or to the carbon atom C².
Preferably, R may be selected from the group consisting of:

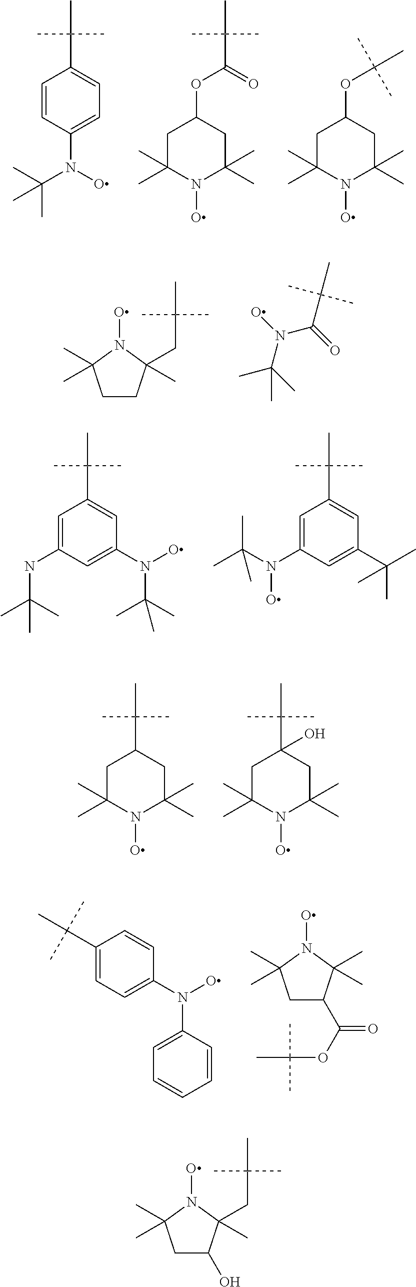

In particular, said monomer may be 2,2,6,6-tetramethylpiperidinyl-oxy-4-yl methacrylate.

In another preferred embodiment, when R is a substituent having a nitrogen atom able to form nitroxide radicals under oxidative conditions, the polymer formed at the end of step (b) or (b″) may be oxidized to form said second active material. The oxidation is carried out in presence of an oxidant able to oxidize a nitrogen atom to form a nitroxide radical. The oxidation may be carried out by techniques known in the art, for example in presence of a compound comprising a peroxide functional group. Hence, R may be selected from the group consisting of:

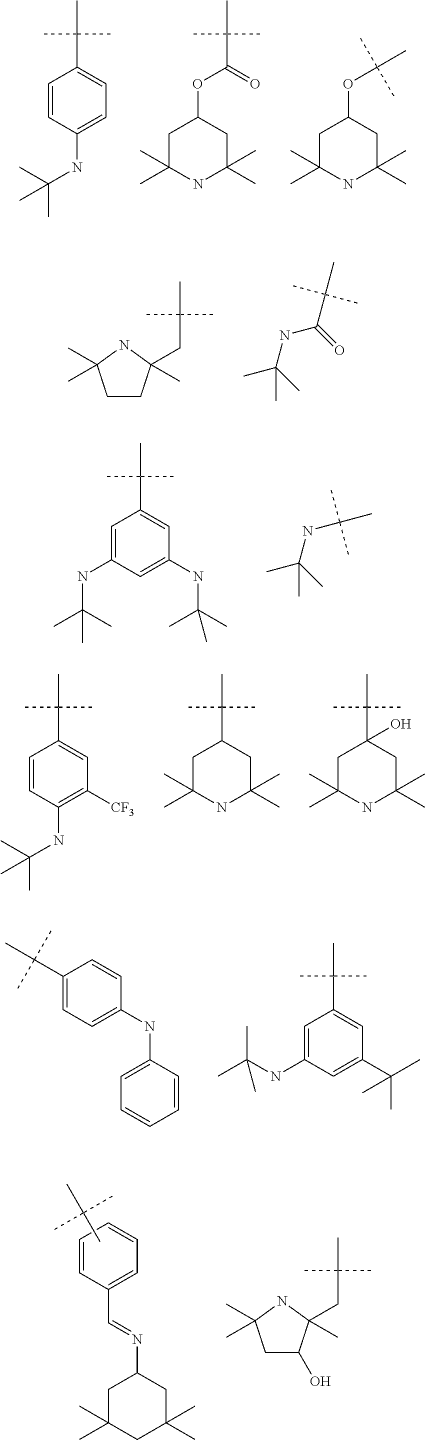

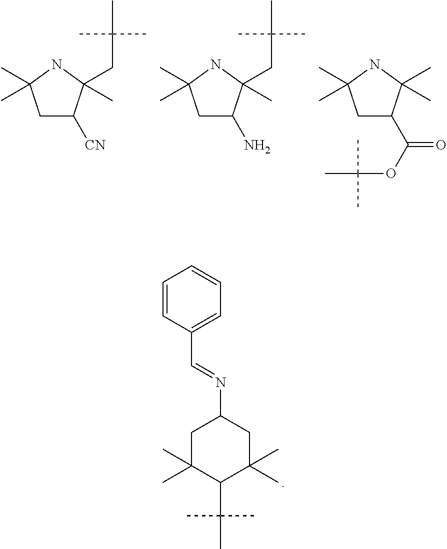

For sake of clarity, hydrogen atoms are not represented on the above substituents R. The dashed lines cross the chemical bond by which the substituent R is linked to the spacer X or to the carbon atom C².
Preferably, R may be selected from the group consisting of:

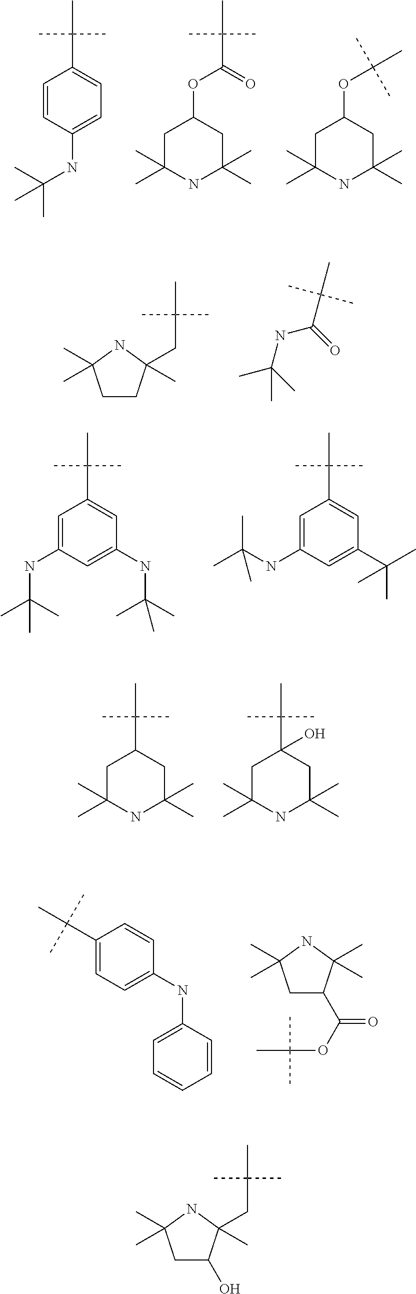

In particular, the monomer may be 2,2,6,6-tetramethyl-4-piperidyl methacrylate.

The cross-linking agent may be one commonly used by the skilled person. In particular, the cross-linking agent may be ethylene glycol dimethacrylate, butanediol dimethylacrylate, hexanediol dimethylacrylate, nonanediol dimethylacrylate, decanediol dimethylacrylate, dodecanediol dimethylacrylate, diethylene glycol methacrylate, triethylene glycol dimethylacrylate. The cross-linking agent allows the increase of the degree of cross-linking in the polymer composite and then influence its insolubility in the organic or aqueous solvent.

In the present process, the process temperature of step (b) may be higher or equal to the melting temperature of the monomer. The melting temperature of the monomer is lower than the temperature at which the polymerization is initiated. When the reaction mixture is heated during step (b) of the present process, the monomer melts before the polymerization thereof is initiated. The dispersion of the conductive particles is therefore more homogeneous within the reaction mixture, i.e. the slurry. The polymer so-formed will have better electrical conductivity due to the controlled dispersion of the conductive particles. The electrically conductive particles may be therefore homogeneously dispersed within the polymer, i.e. the second active material.

The slurry formed in step (b′) may be maintained at the first process temperature under stirring conditions to homogeneously disperse the conductive particles while maintaining the slurry at a low and substantially constant viscosity prior to step (b″). The term “low viscosity” refers to a viscosity lower than 5·10³ Pa·s, preferably lower than 3·10³ Pa·s, more preferably lower than 10³ Pa·s. Said slurry can be easily stirred to allow the dispersion of the conductive particles therein before the viscosity thereof raises a higher viscosity (due to the polymerization) at which the homogenization of the slurry is not more possible.

In particular, the slurry is maintained at the first process temperature for a time of at least 20 seconds, preferably of at least 30 seconds, more preferably for at least 60 seconds. The dispersion of the conductive particles in the slurry is therefore controlled before the polymerization of the monomer is proceeded to a larger extent by the radical polymerization initiator. Said slurry may be maintained at the first process temperature of less than 30 minutes, preferably less than 10 minute, more preferably less than 5 minutes, most preferably less than one minute.

A polymerization initiator, preferably a radical polymerization initiator may also be provided in step (a) of the process in order to favour the initiation of the polymerization. Hence, step (b) of the process may be bringing or heating said reaction mixture to a process temperature which is greater than the melting temperature of the monomer and greater than the temperature at which the polymerization initiator was decomposed, i.e. the temperature at which the polymerization is initiated by the polymerization initiator. In a preferred embodiment, when step (b) is carried out sequentially, step (b′) of the present process may be bringing said reaction mixture to a first process temperature to form a slurry where the polymerization reaction was not initiated, said polymerization is considered to be not initiated when less than 5 wt % of the monomer was converted; and step (b″) heating said slurry to a second process temperature higher than the first process temperature such that the polymerization initiator initiate or propagate the polymerization of the monomer. In a preferred embodiment, the melting temperature of the monomer is lower than the temperature at which the polymerization of the monomer is initiated. The melting temperature of the monomer may be lower than the temperature at which the polymerization initiator, preferably the radical polymerization initiator, is decomposed. Generally, the decomposition of the polymerization initiator will activate or propagate the polymerization of the monomer. The polymerization initiator may decompose slowly or gradually when increasing the temperature. The conversion of the monomer to polymer may be lower than 5 wt % when at most 7 wt % of the polymerization initiator was decomposed, preferably at most 4 wt %, more preferably at most 1 wt %. When the reaction mixture is heated during step (b′) of the present process to the melting temperature of the monomer, said monomer melts before the polymerization thereof is initiated. The dispersion of the conductive particles is therefore more homogeneous within the reaction mixture, i.e. the slurry. The polymer so-formed will have better electrical conductivity due to the controlled dispersion of the conductive particles.

The amount of electrically conductive particles, preferably electrically conductive carbon particles, contained in said second active material prepared according to the present process may range from 0.01 to 50 wt %, preferably from 0.1 to 30 wt %, more preferably from 0.5 to 20 wt %, most preferably from 1 to 20 wt %, even most preferably from 5 to 20 wt %, in particular from 5 to 15 wt % based on the total amount of the second active material.

Preferably, said second active material may be a cross-linked poly(2,2,6,6-tetramethylpiperidinyloxy-4-yl methacrylate). Said cross-linked poly(2,2,6,6-tetramethylpiperidinyloxy-4-yl methacrylate) may contain electrically conductive particles, preferably electrically conductive carbon particles, within the above-mentioned range, in particular from 5 to 20 wt % or from 5 to 15 wt % based on the total amount of said cross-linked poly(2,2,6,6-tetramethylpiperidinyloxy-4-yl methacrylate).

The total weight content of said electrically conductive particles, preferably electrically conductive carbon particles, contained in the composition of the hybrid electrode may be lower than 20 wt %, preferably lower than 15 wt %, more preferably lower than 10 wt %, even more preferably lower than 6 wt % based on the total amount of said first and second active materials and electrically conductive particles, preferably electrically conductive carbon particles.

Preferably, the electrically conductive carbon particles may be carbon nanotubes, carbon fibers, amorphous carbon, mesoporous carbon, exfoliated graphitic carbon or carbon black.

Nanotubes can exist as single-walled nanotubes (SWNT) and multi-walled nanotubes (MWNT), i.e. nanotubes having one single wall and nanotubes having more than one wall, respectively. In single-walled nanotubes a one atom thick sheet of atoms, for example a one atom thick sheet of graphite (also called graphene), is rolled seamlessly to form a cylinder. Multi-walled nanotubes consist of a number of such cylinders arranged concentrically. The arrangement in a multi-walled nanotube can be described by the so-called Russian doll model, wherein a larger doll opens to reveal a smaller doll.

In an embodiment, the nanotubes are multi-walled carbon nanotubes, more preferably multi-walled carbon nanotubes having on average from 5 to 15 walls.

Nanotubes, irrespectively of whether they are single-walled or multi-walled, may be characterized by their outer diameter or by their length or by both. Single-walled nanotubes are preferably characterized by an outer diameter of at least 0.5 nm, more preferably of at least 1 nm, and most preferably of at least 2 nm. Preferably their outer diameter is at most 50 nm, more preferably at most 30 nm and most preferably at most 10 nm. Preferably, the length of single-walled nanotubes is at least 0.1 μm, more preferably at least 1 μm, even more preferably at least 10 μm. Preferably, their length is at most 50 mm, more preferably at most 25 mm. Multi-walled nanotubes are preferably characterized by an outer diameter of at least 1 nm, more preferably of at least 2 nm, 4 nm, 6 nm or 8 nm, and most preferably of at least 10 nm. The preferred outer diameter is at most 100 nm, more preferably at most 80 nm, 60 nm or 40 nm, and most preferably at most 20 nm. Most preferably, the outer diameter is in the range from 10 nm to 20 nm. The preferred length of the multi-walled nanotubes is at least 50 nm, more preferably at least 75 nm, and most preferably at least 100 nm. Their preferred length is at most 20 mm, more preferably at most 10 mm, 500 μm, 250 μm, 100 μm, 75 μm, 50 μm, 40 μm, 30 μm or 20 μm, and most preferably at most 10 μm. The most preferred length is in the range from 100 nm to 10 μm. In an embodiment, the multi-walled carbon nanotubes have an average outer diameter in the range from 10 nm to 20 nm or an average length in the range from 100 nm to 10 μm or both.

Preferred carbon nanotubes are carbon nanotubes having a surface area of 200-400 m²/g (measured by BET method). Preferred carbon nanotubes are carbon nanotubes having a mean number of 5-15 walls.

Preferably, the carbon conductive particles are carbon black particles. Carbon black particles may be almost spherical. The mean diameter of said carbon conductive particles may range from 0.1 to 500 nm, preferably from 0.5 to 250 nm, more preferably from 1 to 100 nm, most preferably from 1 to 50 nm, and in particular from 5 to 20 nm.

As mentioned above, said first active material is a lithium-containing compound, sodium-containing compound or an electroactive conjugated polymer.

The term “electroactive conjugated polymer” as used herein refers to conjugated polymers having the ability to undergo reversible redox reaction when a redox potential is applied to them. Electroactive conjugated polymers as used herein can be polymers or copolymers based on heterocycle moiety as monomers, aniline and substituted aniline derivatives, cyclopentadiene and substituted cyclopentadiene derivatives, phenylene or substituted phenylene derivatives, pentafulvene and substituted pentafulvene derivatives, acetylene and substituted acetylene derivatives, fluorene and substituted fluorene derivatives, pyrene and substituted pyrene derivatives, azulene and substituted azulene derivatives, naphthalene and substituted naphthalene derivatives, indole and substituted indole derivatives, carbazole and substituted carbazole derivatives, or compounds based on formula (III) or (IV):

wherein n is an integer greater than 1, 2, 3, 4, or 5, or is between 1 and 1000, 5 000,

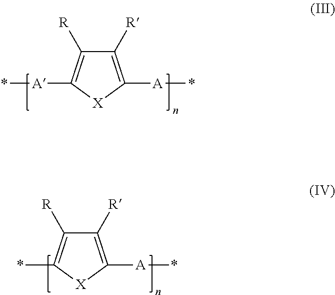

10 000, 100 000, 200 000, 500 000 or 1 000 000 or higher, X is selected from the group consisting of —NR¹—, O, S, PR², SiR⁵R⁶, Se, AsR³, BR⁴ wherein R and R′ which can be identical or not are independently selected from the group consisting of, linked or not, are alkyl, aryl, hydroxyl, alkoxy or R and R′ together with the carbon atoms to which they are attached form a ring selected from aryl, heteroaryl, cycloalkyl, heterocyclyl, wherein R¹, R², R³, R⁴, R⁵ and R⁶ are independently selected from the group consisting of hydrogen, alkyl or aryl group and wherein A and A′ can be heterocycle, alkenyl, alkynyl or aromatic ring and wherein A and A′ can be identical or not.

In a preferred embodiment, the electroactive conjugated polymer may be polyacetylene, polyfluorene or is based on heterocycle moiety as monomers such as pyrrole and substituted pyrrole derivatives, furan and substituted furan derivatives, thiophene and substituted thiophene derivatives or aniline and substituted aniline derivatives.

The term “alkyl” by itself or as part of another substituent refers to a hydrocarbyl radical of formula CₙH₂ₙ₊₁ wherein n is a number greater than or equal to 1. Generally, alkyl groups of this invention comprise from 1 to 6 carbon atoms, preferably from 1 to 4 carbon atoms, more preferably from 1 to 3 carbon atoms, still more preferably 1 to 2 carbon atoms. Alkyl groups may be linear or branched and may be substituted as indicated herein. When a subscript is used herein following a carbon atom, the subscript refers to the number of carbon atoms that the named group may contain. Thus, for example, C₁-C₄ alkyl means an alkyl of one to four carbon atoms. C₁-C₆ alkyl includes all linear, or branched alkyl groups with between 1 and 6 carbon atoms, and thus includes methyl, ethyl, n-propyl, i-propyl, butyl and its isomers (e.g. n-butyl, i-butyl and t-butyl); pentyl and its isomers, hexyl and its isomers.

The term “aryl” as used herein refers to a polyunsaturated, aromatic hydrocarbyl group having a single ring (i.e. phenyl) or multiple aromatic rings fused together (e.g. naphtyl) or linked covalently, typically containing 5 to 12 atoms; preferably 6 to 10, wherein at least one ring is aromatic. The aromatic ring may optionally include one to two additional rings (either cycloalkyl, heterocyclyl or heteroaryl) fused thereto. Aryl is also intended to include the partially hydrogenated derivatives of the carbocyclic systems enumerated herein. Non-limiting examples of aryl comprise phenyl, biphenylyl, biphenylenyl, 5- or 6-tetralinyl, 1-, 2-, 3-, 4-, 5-, 6-, 7- or 8-azulenyl, naphthalen-1- or -2-yl, 4-, 5-, 6 or 7-indenyl, 1-2-, 3-, 4- or 5-acenaphtylenyl, 3-, 4- or 5-acenaphtenyl, 1-, 2-, 3-, 4- or 10-phenanthryl, 1- or 2-pentalenyl, 4- or 5-indanyl, 5-, 6-, 7- or 8-tetrahydronaphthyl, 1,2,3,4-tetrahydronaphthyl, 1,4-dihydronaphthyl, 1-, 2-, 3-, 4- or 5-pyrenyl.

The aryl ring can optionally be substituted by one or more substituent(s). An “optionally substituted aryl” refers to an aryl having optionally one or more substituent(s) (for example 1 to 5 substituent(s)), for example 1, 2, 3 or 4 substituent(s) at any available point of attachment selected independently in each incidence. Unless provided otherwise, non-limiting examples of such substituents are selected from halogen, hydroxyl, oxo, nitro, amino, cyano, alkyl, cycloalkyl, alkenyl, alkynyl, cycloalkylalkyl, C₁-C₄ alkylamino, C₁-C₄ dialkylamino, alkoxy, aryl, heteroaryl, arylalkyl, haloalkyl, haloalkoxy, alkoxycarbonyl, alkylcarbamoyl, heteroarylalkyl, alkylsulfonamide, heterocyclyl, alkylcarbonylaminoalkyl, aryloxy, alkylcarbonyl, acyl, arylcarbonyl, carbamoyl, alkylsulfoxide, alkylcarbamoylamino, sulfamoyl, N—C₁-C₄-alkylsulfamoyl or N,N—C₁-C₄ dialkylsulfamoyl, —SO₂R^{c}, alkylthio, carboxyl, and the like, wherein R^{c} is C₁-C₄ alkyl, haloalkyl, C₃-C₆cycloalkyl, C₁-C₄ alkylsulfonamido or optionally substituted phenylsulfonamido.

The term “heteroaryl” as used herein by itself or as part of another group refers but is not limited to 5 to 12 carbon-atom aromatic rings or ring systems containing 1 to 2 rings which are fused together or linked covalently, typically containing 5 to 6 atoms; at least one of which is aromatic in which one or more carbon atoms in one or more of these rings can be replaced by oxygen, nitrogen or sulfur atoms where the nitrogen and sulfur heteroatoms may optionally be oxidized and the nitrogen heteroatoms may optionally be quaternized. Such rings may be fused to an aryl, cycloalkyl, heteroaryl or heterocyclyl ring. Non-limiting examples of such heteroaryl, include: pyrrolyl, furanyl, thiophenyl, pyrazolyl, imidazolyl, oxazolyl, isoxazolyl, thiazolyl, isothiazolyl, triazolyl, oxadiazolyl, thiadiazolyl, tetrazolyl, oxatriazolyl, thiatriazolyl, pyridinyl, pyrimidyl, pyrazinyl, pyridazinyl, oxazinyl, dioxinyl, thiazinyl, triazinyl, imidazo[2,1-b][1,3]thiazolyl, thieno[3,2-b]furanyl, thieno[3,2-b]thiophenyl, thieno[2,3-d][1,3]thiazolyl, thieno[2,3-d]imidazolyl, tetrazolo[1,5-a]pyridinyl, indolyl, indolizinyl, isoindolyl, benzofuranyl, isobenzofuranyl, benzothiophenyl, isobenzothiophenyl, indazolyl, benzimidazolyl, 1,3-benzoxazolyl, 1,2-benzisoxazolyl, 2,1-benzisoxazolyl, 1,3-benzothiazolyl, 1,2-benzoisothiazolyl, 2,1-benzoisothiazolyl, benzotriazolyl, 1,2,3-benzoxadiazolyl, 2,1,3-benzoxadiazolyl, 1,2,3-benzothiadiazolyl, 2,1,3-benzothiadiazolyl, thienopyridinyl, purinyl, imidazo[1,2-a]pyridinyl, 6-oxo-pyridazin-1(6H)-yl, 2-oxopyridin-1(2H)-yl, 6-oxo-pyridazin-1(6H)-yl, 2-oxopyridin-1(2H)-yl, 1,3-benzodioxolyl, quinolinyl, isoquinolinyl, cinnolinyl, quinazolinyl, quinoxalinyl.

The term “cycloalkyl” as used herein is a cyclic alkyl group, that is to say, a monovalent, saturated, or unsaturated hydrocarbyl group having 1 or 2 cyclic structure. Cycloalkyl includes all saturated hydrocarbon groups containing 1 to 2 rings, including monocyclic or bicyclic groups. Cycloalkyl groups may comprise 3 or more carbon atoms in the ring and generally, according to this invention comprise from 3 to 10, more preferably from 3 to 8 carbon atoms still more preferably from 3 to 6 carbon atoms. The further rings of multi-ring cycloalkyls may be either fused, bridged and/or joined through one or more spiro atoms. Cycloalkyl groups may also be considered to be a subset of homocyclic rings discussed hereinafter. Examples of cycloalkyl groups include but are not limited to cyclopropyl, cyclobutyl, cyclopentyl, cyclohexyl, with cyclopropyl being particularly preferred. An “optionally substituted cycloalkyl” refers to a cycloalkyl having optionally one or more substituent(s) (for example 1 to 3 substituent(s), for example 1, 2 or 3 substituent(s)), selected from those defined above for substituted alkyl. When the suffix “ene” is used in conjunction with a cyclic group, this is intended to mean the cyclic group as defined herein having two single bonds as points of attachment to other groups.

The terms “heterocyclyl” or “heterocyclo” as used herein by itself or as part of another group refer to non-aromatic, fully saturated or partially unsaturated cyclic groups (for example, 3 to 7 member monocyclic, 7 to 11 member bicyclic, or containing a total of 3 to 10 ring atoms) which have at least one heteroatom in at least one carbon atom-containing ring. Each ring of the heterocyclic group containing a heteroatom may have 1, 2, 3 or 4 heteroatoms selected from nitrogen atoms, oxygen atoms and/or sulfur atoms, where the nitrogen and sulfur heteroatoms may optionally be oxidized and the nitrogen heteroatoms may optionally be quaternized. The heterocyclic group may be attached at any heteroatom or carbon atom of the ring or ring system, where valence allows. The rings of multi-ring heterocycles may be fused, bridged and/or joined through one or more spiro atoms. An optionally substituted heterocyclic refers to a heterocyclic having optionally one or more substituent(s) (for example 1 to 4 substituent(s), or for example 1, 2, 3 or 4 substituent(s)), selected from those defined above for substituted aryl.

Non limiting exemplary heterocyclic groups include aziridinyl, oxiranyl, thiiranyl, piperidinyl, azetidinyl, 2-imidazolinyl, pyrazolidinyl imidazolidinyl, isoxazolinyl, oxazolidinyl, isoxazolidinyl, thiazolidinyl, isothiazolidinyl, piperidinyl, succinimidyl, 3H-indolyl, indolinyl, isoindolinyl, 2H-pyrrolyl, 1-pyrrolinyl, 2-pyrrolinyl, 3-pyrrolinyl, pyrrolidinyl, 4H-quinolizinyl, 2-oxopiperazinyl, piperazinyl, homopiperazinyl, 2-pyrazolinyl, 3-pyrazolinyl, tetrahydro-2H-pyranyl, 2H-pyranyl, 4H-pyranyl, 3,4-dihydro-2H-pyranyl, oxetanyl, thietanyl, 3-dioxolanyl, 1,4-dioxanyl, 2,5-dioximidazolidinyl, 2-oxopiperidinyl, 2-oxopyrrolodinyl, indolinyl, tetrahydropyranyl, tetrahydrofuranyl, tetrahydrothiophenyl, tetrahydroquinolinyl, tetrahydroisoquinolin-1-yl, tetrahydroisoquinolin-2-yl, tetrahydroisoquinolin-3-yl, tetrahydroisoquinolin-4-yl, thiomorpholin-4-yl, thiomorpholin-4-ylsulfoxide, thiomorpholin-4-ylsulfone, 1,3-dioxolanyl, 1,4-oxathianyl, 1,4-dithianyl, 1,3,5-trioxanyl, 1H-pyrrolizinyl, tetrahydro-1,1-dioxothiophenyl, N-formylpiperazinyl, and morpholin-4-yl.

The term “alkenyl” as used herein refers to an unsaturated hydrocarbyl group, which may be linear, branched or cyclic, comprising one or more carbon-carbon double bonds. Alkenyl groups thus comprise between 2 and 6 carbon atoms, preferably between 2 and 4 carbon atoms, still more preferably between 2 and 3 carbon atoms. Examples of alkenyl groups are ethenyl, 2-propenyl, 2-butenyl, 3-butenyl, 2-pentenyl and its isomers, 2-hexenyl and its isomers, 2,4-pentadienyl and the like. An optionally substituted alkenyl refers to an alkenyl having optionally one or more substituent(s) (for example 1, 2 or 3 substituent(s), or 1 to 2 substituent(s)), selected from those defined above for substituted alkyl.

The term “alkynyl” as used herein, similarly to alkenyl, refers to a class of monovalent unsaturated hydrocarbyl groups, wherein the unsaturation arises from the presence of one or more carbon-carbon triple bonds. Alkynyl groups typically, and preferably, have the same number of carbon atoms as described above in relation to alkenyl groups. Non limiting examples of alkynyl groups are ethynyl, 2-propynyl, 2-butynyl, 3-butynyl, 2-pentynyl and its isomers, 2-hexynyl and its isomers and the like. An optionally substituted alkynyl refers to an alkynyl having optionally one or more substituent(s) (for example 1 to 4 substituent(s), or 1 to 2 substituent(s)), selected from those defined above for substituted alkyl.

In a preferred embodiment, said first active material is a lithium-containing material. Preferably, said lithium-containing material is selected such that its equilibrium redox potential is lower or equal, preferably lower than the equilibrium redox potential of the second active material. Preferably, said lithium-containing material is selected such that its rate performance is lower than the rate performance of the second active material. Said lithium-containing material may be LiCoO₂, LiNiₐCo_{b}Al_{c}Mn_{d}O_{2-y} (in particular LiNi_{0.5}Mn_{1.5}O₄, LiCr_{0.5}Mn_{1.5}O₄, LiCo_{0.5}Mn_{1.5}O₄, LiCoMnO₄, LiNi_{0.5}Mn_{0.5}O₂, LiNi_{0.33}Mn_{0.33}Co_{0.33}O₂, LiNi_{0.8}CO_{0.2}O₂ and LiNi_{0.5}Mn_{1.5-z}Ti_{z}O₄ wherein z ranges from 0 to 1.5), LiMn₂O₄, LiNiO₂, LiFePO₄, LiCoPO₄, LiMnPO₄ or Li₄Ti₅O₁₂. In particular, said first active material may be LiCoO₂, LiMn₂O₄, LiFePO₄. Said first active material may also be TiS₂, TiS₃, amorphous MoS₂, Cu₂V₂O₃, amorphous V₂O—P₂O₅, MoO₃, V₂O₅ or V₆O₁₃.

Alternatively, said first active material is a sodium-containing material. Preferably, said sodium-containing material is selected such that its equilibrium redox potential is lower than the equilibrium redox potential of the second active material. Preferably, said sodium-containing material is selected such that its rate performance is lower than the rate performance of the second active material. Said sodium-containing material may be NaFePO₄, NaCrO₂, NaCoO₂, NaVO₂, Na₃V₂(PO₄)₃, NaNi_{0.5}Mn_{0.5}O₂.

Said first and second active materials may be selected such that the equilibrium redox potential of the second active material is equal or greater, preferably greater, than the equilibrium redox potential of the first active material. The rate performance of the second material may be higher than the rate performance of the first active material; and the weight content of said carbon conductive particles is lower than 25 wt % based on the total amount of said first and second active material and carbon conductive particles in said hybrid electrode. The charge and discharge capabilities as well as the life cycle of the hybrid positive electrode according to the present invention are considerably increased as compared to the positive electrode known in the art. The second active material allows the postponement of the voltage rise up on the first active material and keeps the operation voltage window safe. Furthermore, the second active material allows the lowering of the degradation rate of the first active material when the hybrid positive electrode is used. The physical properties of the second active material may be induced by its preparation process allowing a greater power performance, such as output performance.

Furthermore, the rate performance of the electrode material, either the first or the second active material, is defined as the normalized capacity retention of said active material as function of the charge/discharge cycling rate. The capacity retention of each active material can be determined by techniques known in the art. As illustrated in FIG. 4 with respect to a specific embodiment of the present invention, the capacity retention of the second active material, i.e. PTMA, is much better than of first active materials, i.e. LiFePO₄. Hence, with the increase in the cycling rate, PTMA capacity retention decrease is less pronounced that in case of LiFePO₄. The capacity retention of the first active material, i.e. LiFePO₄, dramatically drops much faster when the cycling rate is increased. This demonstrates that the rate performance of the second active material is greater than the rate performance of the first active material. The ratio between the normalized capacity retention of the second active material and the normalized capacity retention of the first active material is greater than 1 at a charge/discharge rate greater than 1 C.

Preferably, at a defined value of number of charge/discharge cycles, the retained capacity of the second active material electrode and of the hybrid positive electrode according to the present invention is greater than 80%, which corresponds to 0.8 if normalized, preferably greater than 85%, which corresponds to 0.85 if normalized, more preferably greater than 90%, which corresponds to 0.9 if normalized, most preferably greater than 95%, which corresponds to 0.95 if normalized. Preferably, the normalized capacity of the second active material and the normalized capacity of the hybrid electrode according to the present invention has the above-mentioned values when the number of cycles is greater than 250 cycles, more preferably greater than 500 cycles, most preferably greater than 1000 cycles, even most preferably greater than 2000 cycles.

In a preferred embodiment, the difference between the equilibrium redox potential of said second active material and the equilibrium redox potential of said first active material ranges from 1 mV to 1V, preferably from 1 mV to 0.5V, more preferably from 10 to 300 mV.

In a preferred embodiment, the amount of said first and second active material is determined such that the ratio between the specific capacity of said first active material and the specific capacity of said second active material, based on the theoretical capacity of each material, ranges from 10:1 to 1:10, preferably from 2.5:1 to 1:2.5, more preferably from 2.0:1 to 1:2.0, even more preferably from 1.5:1 to 1:1.5, most preferably from 1.2:1 to 1:1.2, even most preferably 1.1:1 to 1:1.1, and in particular is 1.

In a preferred embodiment, the capacity loss of the second active material and/or of the hybrid positive electrode according to the present invention after more than 1500 cycles at charge and discharge rate of at least 5 C is lower than 50%, preferably lower than 40%, more preferably lower than 30% and most preferably lower than 20%.

In a preferred embodiment, the second active material and/or the hybrid positive electrode has a capacity retention greater than the capacity retention of the first active material at elevated rate, preferably greater than 5 C rate, more preferably greater than 10 C rate, most preferably greater than 20 C rate, even most preferably greater than 30 C rate. The capacity retention may be defined as (the ratio between the retained capacity after a given number of charge discharge cycles expressed as mAh/g and the first cycle capacity expressed as mAh/g at a given C rate)*100. The second active material may have capacity retention of at least 80%, preferably of at least 90%, more preferably of at least 92%, most preferably of at least 95% after being cycled for at least 1000 cycles.

The hybrid positive electrode may further comprise a metallic layer on which a composition comprising the first and second active materials and carbon electrically conductive particles is coated. The metallic layer may be an aluminium layer. The hybrid positive electrode may further comprise additives such as supplementary carbon conductive particles and/or a binder. The weight content of additives may range from 0 to 20 wt % based on the total weight of the composition. The term additives as used herein encompass the supplementary carbon conductive particles and the binder. The binder is for example carboxymethyl cellulose (CMC), polyvinylidene fluoride (PVDF), PTFE or PVDF copolymer. Said supplementary carbon conductive particles may be carbon nanotubes, carbon fibers, amorphous carbon, mesoporous carbon, exfoliated graphitic carbon or carbon black.

The hybrid positive electrode may be prepared by mixing the second active material with supplementary conductive carbon particles and a binder to form a first slurry which is subsequently added to a second slurry formed by mixing the first active material with supplementary conductive carbon particles and a binder. Generally, said supplementary conductive carbon particles were disposed on the surface of said first or second active material. The weight content of the electrically conductive particles in the composition may optionally encompass the amount of the supplementary conductive carbon particles. The mixture so-obtained is coated on the metallic layer. Hence, the composition comprising the first and second active materials, electrically conductive particles optionally encompassing supplementary conductive carbon particles and the binder forms a single layer coated on the metallic layer, preferably an aluminium layer.

In a second aspect of the present invention, a non-aqueous electrolyte secondary battery is provided. Said non-aqueous electrolyte secondary battery comprises a hybrid positive electrode according to the present invention, a negative electrode and an electrolyte.

The negative electrode may be, but not limited to, graphitic carbon, silicon, tin, aluminium, Li₄Ti₆O₁₂, SnO₂, copper oxide, germanium oxide, silicon oxide, NiSn, AlNiSi, or composite thereof.

Said electrolyte may be a mixture of lithium salt in non-aqueous solvent. The Lithium salt may be LiPF₆, LiClO₄, LiBF₄, LiCF₃SO₃, Li(CF₃SO₂)₂N, Li(C₂F₆SO₂)₂N, Li(CF₃SO₂)₃C, Li(C₂F₆SO₂), ethylene carbonate, propylene carbonate, dimethyl carbonate, diethyl carbonate, methyl ethyl carbonate, gamma-butyrolactone, tetrahydrofuran, dioxolane, sulfolane, dimethylformamide, dimethylacetamide or N-methyl-2-pyrrolidone. These solvents or the salts may be used alone or in combination of two or more of the solvents or salts. In addition, stabilizing additives may be added to the electrolyte. Gel polymer or solid-state electrolyte may also be used.

Preferably, said non-aqueous electrolyte secondary battery comprises a hybrid positive electrode containing a second active material having solubility lower than 0.1 wt % in the electrolyte at room temperature. Said second active material may be a cross-linked poly(2,2,6,6-tetramethylpiperidinyloxy-4-yl methacrylate), preferably prepared according to the process disclosed above.

In a third aspect, the hybrid positive electrode according to the present invention is suitable for an electricity storage device.

### EXAMPLES

Synthesis of the second active material: cross-linked PTMA/C composite.

Cross-linked PTMA/C composite was synthesized through a solvent free, molten monomer polymerization reaction. To enable the electrical conductivity, approx. 15% by weight of acetylene black was added to the reactant mixture. A highly dispersed PTMA—carbon material with an intimate contact between the two components is produced. The addition of acetylene black also was found to enhance the brittleness of the composite and ensured fine milling of the PTMA powder.

In a typical synthesis, 1 g of acetylene black (MTI Corporation) was thoroughly mixed with 6 g of 2,2,6,6-tetramethyl-4-piperidyl methacrylate (TMPM, TCI Co. Ltd.), 188 μl ethylene glycol dimethacrylate cross-linking agent (Across Organics) and 40 mg of recrystallized azoisobutyronitrile (Across Organics) with the addition of minimal amount of dichloromethane (drop wise addition of 2-5 ml, Across Organics) to uniformly disperse the constituents. The mixture was thoroughly milled during and after the dichloromethane evaporation with the aid of ˜6 stainless-steel balls (2 mm in diameter). Subsequently, the solid mixture was transferred into a glass vial, vacuum pumped and purged with argon three times. The sealed vial was heated at 65° C. 2,2,6,6-tetramethyl-4-piperidyl methacrylate (m.p. 61° C.) melts generating a liquid dispersion of the constituents in molten monomer. The sealed vial was then heated slowly up to 80° C. (30 minutes) to initiate and propagate the polymerization for 2 hours. After cooling down, the solid content was swelled, extracted and washed with dichloromethane. The solid cross-linked poly(2,2,6,6-tetramethyl-4-piperidinyl)methacrylate/C (PTMPM/C) was finely grinded to yield a powder (yield>95%). The obtained polymer is insoluble in any organic solvent.

To synthesize the PTMA/C, 1 g of PTMPM/C (0.85 g, 3.77 mmol of PTMPM) was dispersed in 80 ml dichloromethane with the aid of sonication. The dispersion was cooled down in an ice bath. The oxidation was performed using meta-Chloroperoxybenzoic acid (mCPBA, Across Organics). The mCPBA (70-75%) was purified prior to use. Meta-chlorobenzoic acid impurity is removed from mCPBA previously dissolved in toluene (50 g/L) by five successive washing with a phosphate buffer solution (pH 7.5). The organic layer was dried over MgSO₄, filtered and concentrated under reduced pressure to obtain pure mCPBA powder. 680 mg (4 mmol, 1.05 equiv.) of freshly purified mCPBA was dissolved in 80 ml dichloromethane and cooled down in an ice bath. This solution was added drop wise to the PTMPM/C dispersion and left to react at 0° C. for 6 hours. The solid was filtered while cold and washed with cooled (˜0° C.) dichloromethane first. The solid product was subsequently washed with dichloromethane, acetone, water and methanol. The obtained PTMA/C (yield>95%) was dried in vacuum and finely grinded before use. The synthesized PTMA/C yielded a specific capacity of 100 mAh/g. The synthesized PTMA/C has a cross-linking percentage of 3.6%.

Commercial LiFePO₄ (MTI Corporation, particle size D₅₀=2.5-5 μm) was used as received. For the electrochemical testing, the composition of the electrode material was 80:10:10 wt. % of first and second active materials:conductive carbon:binder.

Electrode Preparation

PTMA slurry: 800 mg of PTMA/C was thoroughly mixed with 100 mg of acetylene black (MTI Corporation). To the above mixture, 5 g of 2% by weight carboxymethyl cellulose (CMC, MTI Corporation) solution in water was added. The slurry was thoroughly stirred and coated on aluminum foil at 100-600 μm thickness using doctor blade. The coating was first left to dry in air and then vacuum dried at 55° C. for 12 h. Disks with different dimensions were subsequently punched, pressed at 6 tonns and tested in half-cell configuration depending on the required electrode capacity.

LiFePO₄ slurry preparation: 800 mg of LiFePO₄ was thoroughly mixed with 100 mg of acetylene black (MTI Corporation). To the above mixture, 5 g of 2% by weight carboxymethyl cellulose (CMC, MTI Corporation) solution in water was added. The slurry was thoroughly stirred and coated on aluminum foil at 50-250 μm thickness using doctor blade. The coating was first left to dry in air and then vacuum dried at 55° C. for 12 h. Disks with different dimensions were subsequently punched, pressed at 6 tonns and tested in half-cell configuration depending on the required electrode capacity.

Hybrid positive electrode preparation: different amounts of the above PTMA and LiFePO₄ slurries were thoroughly mixed in order to obtain the slurry for the hybrid electrode preparation. For example, for 1:1 capacity ratio, 1 g of LiFePO₄ slurry was mixed with 2 g of PTMA slurry. The obtained slurry was coated on aluminium foil at 250 μm thickness using doctor blade. The coating was first left to dry in air and then vacuum dried at 55° C. for 12 h. 1 cm² disks were subsequently punched, pressed at 6 tonns and tested in half-cell configuration. The specific capacity of the so-prepared hybrid electrode was 126 mAh/g.

Electrochemical testing was performed in half-cell configuration using Li-metal foil (Alfa Aesar) as reference and counter electrode. CR2032 coin-cells (MTI Corporation) and custom made Swagelok Cells (X2Labware) were used without any significant difference in the outcome. One sheet of Celgard separator (MTI Corporation) was placed in between the working electrode and Lithium. The cells were activated by soaking the electrodes and the separator with 1M LiPF₆ in 1:1 by vol. mixture of EC/DEC (Novolyte). The cells were assembled in an argon-filled glove box. The cyclic voltammetry, galvanostatic cycling and coulometric titration experiments were performed using Arbin BT-2043 multichannel potentiostat battery tester. EIS measurements were realized using CHI660B potentiostat.

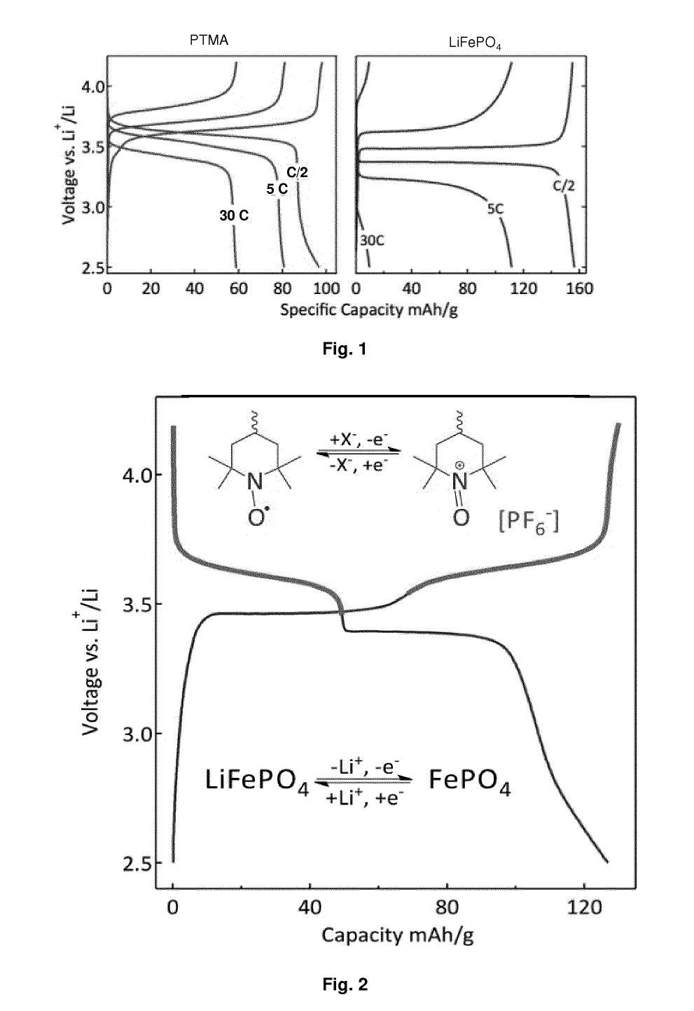

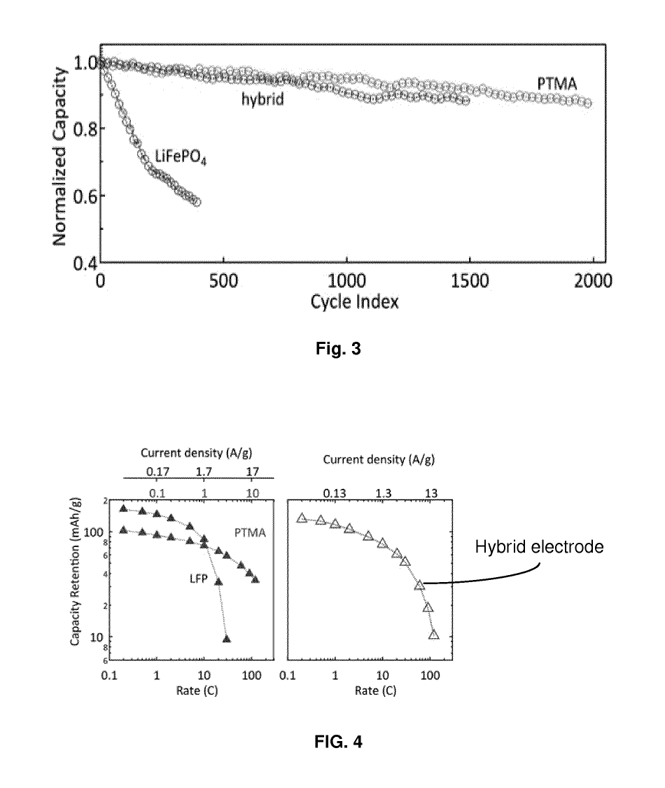

FIG. 1 represents the capacity retention as function of C-rate of an electrode made of PTMA and of LiFePO₄ respectively. The PTMA electrode had a 200 μm coating thickness while the LiFePO₄ electrode had 50 μm coating thickness. PTMA electrode had a better capacity retention and lower electrode polarization at elevated rates. At 30 C charge/discharge PTMA retained 60% of the capacity while LiFePO₄ showed high electrode polarization and retained only 6% of the nominal. At a moderate 5 C rate, LiFePO₄ delivered 110 mAh/g, considerably higher than 80 mAh/g for PTMA. However, upon extended cycling at 5 C rate, LiFePO₄ showed faster capacity decay while PTMA retained more than 80% of its initial capacity after 2,000 cycles (see FIG. 3). The degradation of LiFePO₄ electrode at elevated current densities originates from electrode overcharging, particle amorphization, decomposition and dissolution. In turn, the chemical stability of the nitroxide radical, simple one-electron transfer reaction and absence of any change in the amorphous structure of PTMA ensures the long cyclability of PTMA.

FIG. 2 represents the voltage profile of the hybridized PTMA/LiFePO₄ electrode according to the present invention at a current density of 26 mAh/g. Two plateaus were discernible in charge and discharge and corresponded to separate components redox process. PTMA had theoretical specific capacity of 111 mAh/g with a flat-potential profile response at an average voltage of 3.6V vs. Li/Li⁺ (FIG. 2). The electron transfer kinetics of the nitroxide radical was measured as high as 10⁻¹ cm/s resulting in ultra-fast charge transfer capability within the radical polymer layer. The cross-linked PTMA disclosed in the present invention displayed long cycle lifetime, excellent rate capability and low electrode polarization at elevated rates, preferably at rates higher than 10 C. In contrast, LiFePO₄ was a crystalline inorganic material with a flat de/insertion plateau potential at 3.4V vs. Li/Li⁺ (FIG. 2). It had high theoretical specific capacity of 170 mAh/g. However, low electrical conductivity and anisotropic Li⁺ diffusivity were still challenging for high power applications and long cycle life at elevated rates. Particle size reduction, carbon coating and functional modification have led to improved power capabilities however, at the expense of increased manufacturing costs. In the present application, micrometer-size LiFePO₄ particles can be recharged at technologically relevant rates and cycled for more than 1,000 cycles when hybridized with PTMA.

The capacity retention plots (FIG. 4) showed that the hybrid electrode had better rate performance than the LiFePO₄ electrode yet, slightly lower than PTMA. The hybrid electrode has shown excellent cycle life-time, lower than 12.5% capacity loss after 1,500 cycles at 5 C charge/discharge rate, mimicking the PTMA electrode behavior rather than that of LiFePO₄ (FIG. 3). The behavior of the LiFePO₄ electrode, accentuated at high rates, induces local over-potentials, ultimately leading to the degradation of the LiFePO₄. In the hybrid electrode according to the present invention, the uniform dispersion of carbon particles in the PTMA matrix and the intimate PTMA—LiFePO₄ contact ensure a good charge and ionic transfer interface. Moreover, the overall electrode potential is limited by PTMA, avoiding voltage abuse on LiFePO₄ particles.

### Example 2

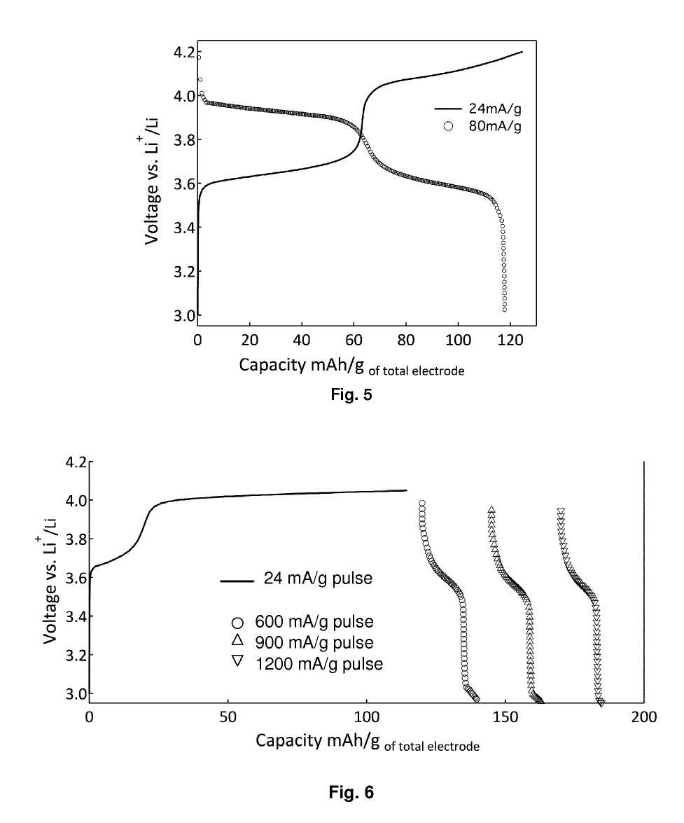

Example 1 was reproduced with the exception that LiCoO₂ was used instead of LiFePO₄, at capacity ratio of 1:1. FIG. 5 represents the voltage profile of the hybridized PTMA/LiCoO₂ electrode according to the present invention. The cell was charged slowly at C/5 and then discharged at higher rate of C/1.5.

### Example 3

Example 1 was reproduced with the exception that LiMn₂O₄ was used instead of LiFePO₄, at capacity ratio of 1:5. FIG. 6 represents the voltage profile of the hybridized PTMA/LiMn₂O₄ electrode according to the present invention. The cell was charged slowly at C/5 and then pulse discharge at very high rates with 1 hour relaxation in between. It clearly shows that each time a high discharge pulse was applied, the LiMn₂O₄ plateau was not observed and only PTMA was observed. During the relaxation LiMn₂O₄ re-charges the PTMA so that it can provide again high pulse discharge.

The terms and descriptions used herein are set forth by way of illustration only and are not meant as limitations. Those skilled in the art will recognize that many variations are possible within the spirit and scope of the invention as defined in the following claims, and their equivalents, in which all terms are to be understood in their broadest possible sense unless otherwise indicated. As a consequence, all modifications and alterations will occur to others upon reading and understanding the previous description of the invention. In particular, dimensions, materials, and other parameters, given in the above description may vary depending on the needs of the application.

1. Hybrid positive electrode comprising a composition which comprises:
(a) a first active material being a lithium-containing compound, a sodium-containing compound, or an electroactive conjugated polymer,
(b) a second active material being a polymer containing a nitroxide radical, and
(c) electrically conductive particles, preferably carbon electrically conductive particles, the weight content of said electrically conductive particles is lower than 25 wt % based on the total amount of said first and second active materials and electrically conductive particles in the composition,
characterized in that, parts of the electrically conductive particles are homogeneously dispersed within said second active material.

2. Hybrid positive electrode according to claim 1, wherein said second active material is obtained by a process comprising the steps of:
(a) providing electrically conductive particles, a monomer, and a cross-linking agent to form a reaction mixture,
said monomer being of formula (II) R^{a}R^{b}C¹═C²R^{c}((X)ₘ—R) (II) wherein
R^{a}, R^{b}, R^{c} each are independently from the other, hydrogen or an hydrocarbyl group having from 1 to 20 carbon atoms;
X is a spacer; m is an integer from 0 to 5;
R is a substituent having a nitroxide radical as functional group or a nitrogen atom able to form nitroxide radicals under oxidative conditions;
(b) bringing said reaction mixture to a process temperature which is greater than the melting temperature of the monomer and than the temperature at which the polymerization is activated, said polymerization is considered to be activated when at least 5% of the monomer was converted,
(c) retrieving said second active material, preferably step (b) is carried out in a reaction mixture comprising not more than 100 wt %, preferably not more than 30 wt %, of an organic solvent with respect to the total weight of the monomer.

3. Hybrid positive electrode according to claim 1 wherein said second active material is a polymer wherein at least part of the polymeric chain is of formula (I)—[—C¹(R^{a})(R^{b})—C²((X)ₘ—R)(R^{c})—]ₙ—(I) wherein
R^{a}, R^{b}, R^{c} each are independently from the other, hydrogen or an hydrocarbyl group having from 1 to 20 carbon atoms;
X is a spacer; m is an integer from 0 to 5; n is an integer of at least 10;
R is selected from the group consisting of:

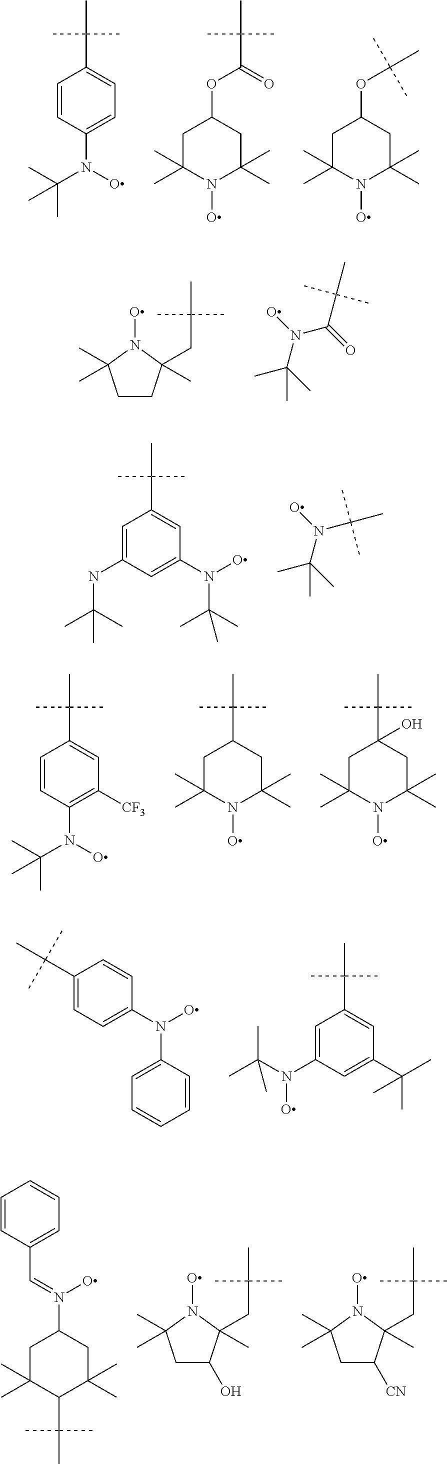

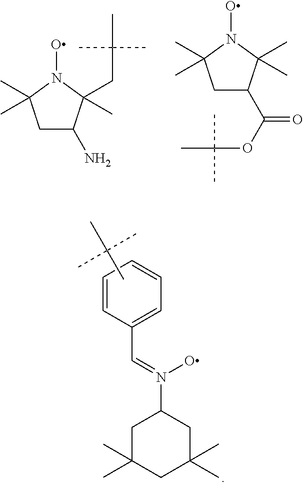

4. Hybrid positive electrode according to claim 1 characterized in that the second active material is a cross-linked poly(2,2,6,6-tetramethylpiperidinyl-oxy-4-yl methacrylate).

5. Hybrid positive electrode according to claim 4 characterized in that the cross-linked poly(2,2,6,6-tetramethylpiperidinyl-oxy-4-yl methacrylate) comprises from 0.1 wt % to 30 wt % of electrically conductive particles based on the total amount of said cross-linked poly(2,2,6,6-tetramethylpiperidinyl-oxy-4-yl methacrylate) in the composition.

6. Hybrid positive electrode according to claim 1 wherein said second active material has a cross-linking percentage ranging from 0.1 to 15%.

7. Hybrid positive electrode according to claim 1 characterized in that the second active material has capacity retention of at least 80% after being cycled for at least 1000 cycles.

8. Hybrid positive electrode according to claim 1 wherein said first active material is a lithium-containing material and is selected from the group consisting of LiCoO₂, LiNi_{0.5}Mn_{1.5}O₄, LiCr_{0.5}Mn_{1.5}O₄, LiCo_{0.5}Mn_{1.5}O₄, LiCoMnO₄, LiNi_{0.5}Mn_{0.5}O₂, LiNi_{0.33}Mn_{0.33}CO_{0.33}O₂, LiNi_{0.8}Co_{0.2}O₂ and LiNi_{0.5}Mn_{1.5-z}Ti_{z}O₄ wherein z ranges from 0 to 1.5, LiMn₂O₄, LiNiO₂, LiFePO₄, LiCoPO₄, LiMnPO₄ or Li₄Ti₅O₁₂.

9. Hybrid positive electrode according to claim 8 wherein said first active material is LiFePO₄, LiCoO₂ or LiMn₂O₄.

10. Hybrid positive electrode according to claim 1 characterized in that the amount of said first and second active material is determined such that the ratio between the specific capacity of said first active material and the capacity of said second active material ranges from 10:1 to 1:10.

11. Hybrid positive electrode according to claim 1 wherein the composition further comprises a binder and supplementary carbon electrically conductive particles.

12. Hybrid positive electrode according to claim 1 further comprising a metallic layer on which said composition is coated and forms a single layer.

13. Hybrid positive electrode according to claim 1 wherein the capacity loss of the second active material or of said hybrid positive electrode after more than 1500 cycles at charge and discharge rate greater than 5 C is lower than 20%.

14. A non-aqueous electrolyte secondary battery comprising a hybrid positive electrode according to claim 1, a negative electrode and an electrolyte

15. Use of the hybrid positive electrode according to claim 1 in an electricity storage device.
